(19) United States
(12) Patent Application Publication
(10) Pub. No.: US 2021/0086070 A1
(43) Pub. Date: Mar. 25, 2021

(54) VOICE COMMAND INTERFACE FOR VIDEO GAMES

(71) Applicant: NVIDIA Corporation, Santa Clara, CA (US)

(72) Inventors: Ryan Albright, Beaverton, OR (US); Ben Goska, Portland, OR (US); Jordan Levy, Beaverton, OR (US); Mike Gemelke, Portland, OR (US); Ankita Garg, Fremont, CA (US); Siddardha Naraharisetti, San Jose, CA (US); Sebastiano Bea, Menlo Park, CA (US)

(21) Appl. No.: 16/581,068

(22) Filed: Sep. 24, 2019

(51) Int. Cl. A63F 13/215; G06F 3/16; G06N 20/00

(52) U.S. Cl. CPC A63F 13/215; G06N 20/00; G06F 3/167

(57) ABSTRACT

Interactive computer applications, such as video games, are generally developed to allow user interaction through input keys of either a keyboard or a remote controller. In some cases, video games can also be developed to allow user interaction through voice commands. In any case, the user is limited to using the specific input keys and/or voice commands preprogrammed within the application to control various aspects of the application. The present disclosure provides a voice command interface that enables use of additional voice commands to control aspects of the application other than the voice commands preprogrammed within the application. The voice command interface can be used for one or more interactive computer applications.

### TECHNICAL FIELD

The present disclosure relates to voice command control for video games or other interactive content.

### BACKGROUND

Typically, video games are developed to allow user interaction through input keys of either a keyboard (e.g. for personal computer (PC)-based gaming) or a remote controller (e.g. for Console-based gaming). In some cases, video games can also be developed to allow user interaction through voice commands. In either case, the player is limited to using the specific input keys and/or voice commands preprogrammed within the video game to control various aspects of the video game (referred to below as “programmed” commands).

There are some situations, however, where the player could benefit from the option to use voice commands (referred to below as “add-on” voice commands) that have not been preprogrammed within the video game. In the most obvious example, add-on voice commands could provide the player with a more intuitive way to play the video game, particularly where the video game developer did not otherwise provide voice command support in the video game. Furthermore, even where the video game developer has provided voice command support in the video game, game play could be simplified for the player by providing an add-on voice command that causes a particular sequence of programmed commands, and that therefore possibly covers a more complicated combination of programmed commands (e.g. that may otherwise require navigation through multiple game menus, etc.).

In another example, for video games developed for PC-based gaming, preprogrammed video commands are usually linked to most or all of the keys on the keyboard, especially for video games with complicated build systems. As a result, it is nearly impossible, or at least substantially more difficult, for the player to instead play the video game using a remote controller having significantly fewer input buttons than a keyboard. This near impossibility, or substantial difficulty, is even more so the case when the video game is not preprogrammed with the option of using voice commands. In this situation, add-on voice commands could be used in combination with the remote controller to provide the player with complete access to the programmed video game commands. Additionally, as similarly noted above, game play could also be simplified for the player by providing an add-on voice command that covers a more complicated combination of programmed commands. Of course, the above mentioned problems are not unique to video games, but may also be encountered for other types of interactive content (e.g. virtual reality applications, television or movie related applications, etc.).

There is a need for addressing these issues and/or other issues associated with the prior art.

### SUMMARY

A method, computer readable medium, and system are disclosed to provide a voice command interface for video games and other types of interactive computer applications. The voice command interface is in communication with an audio input device of a user and an application (e.g. video game). In use, the voice command interface receives, from the audio input device, audio input representing a spoken command of the user. Additionally, the voice command interface processes the audio input to determine an intended result of the spoken command. Further, the voice command interface determines one or more programmed commands within the application that will accomplish the intended result. Still yet, the voice command interface causes the application to perform the one or more programmed commands.

### BRIEF DESCRIPTION OF THE DRAWINGS

FIG. 1 illustrates a flowchart of a method of a voice command interface for an application, in accordance with an embodiment.

FIG. 2A illustrates a block diagram of a system including a voice command interface, in accordance with an embodiment.

FIG. 2B illustrates a communication path involving the voice command interface of FIG. 2A, in accordance with an embodiment.

FIG. 2C illustrates another communication path involving the voice command interface of FIG. 2A, in accordance with an embodiment.

FIG. 3 illustrates a network architecture, in accordance with an embodiment.

FIG. 4 illustrates an exemplary system, in accordance with an embodiment.

FIG. 5A illustrates inference and/or training logic, in accordance with an embodiment.

FIG. 5B illustrates inference and/or training logic, in accordance with an embodiment.

FIG. 6 illustrates training and deployment of a neural network, in accordance with an embodiment.

### DETAILED DESCRIPTION

Interactive computer applications, such as video games, virtual reality applications, television or movie related applications, etc., are generally developed to allow user interaction through input keys of either a keyboard or a remote controller. In some cases, video games can also be developed to allow user interaction through voice commands. In any case, the user is limited to using the specific input keys and/or voice commands preprogrammed within the application to control various aspects of the application. The present disclosure provides a voice command interface that enables use of additional voice commands to control aspects of the application other than the voice commands preprogrammed within the application. The voice command interface can be used for one or more interactive computer applications.

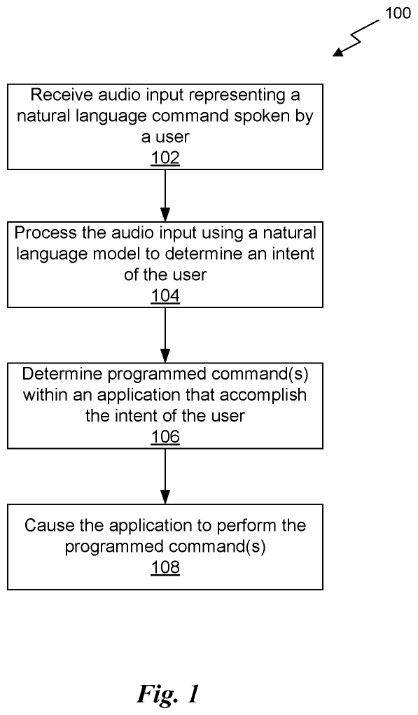

FIG. 1 illustrates a flowchart of a method 100 of a voice command interface for an application, in accordance with an embodiment. The method 100 may be performed the context of a processing unit and/or by a program, custom circuitry, or by a combination of custom circuitry and a program. For example, the method 100 may be executed by a GPU (graphics processing unit), CPU (central processing unit), or any processor described below. Furthermore, persons of ordinary skill in the art will understand that any system that performs method 100 is within the scope and spirit of embodiments of the present disclosure.

In operation 102, audio input representing a natural language command spoken by a user is received. The audio input may be received from an audio input device in association with an interaction by the user with the application, such as in association with the user playing a video game. For example, the audio input may be received through a microphone on a remote controller being used by the user to interact with the application, a headset worn by the user that is connected to a computer or console presenting the application, etc. As noted above, the command is a natural language command, or in other words is a sequence of one or more words spoken using natural, conversational speech.

In operation 104, the audio input is processed using a natural language model to determine an intent of the user. The intent may be any outcome intended by the user. In one embodiment, the intent may be for an outcome (e.g. result, action, etc.) in a particular application. Just by way of example, in a video game that involves building structures, the intent of the natural language command spoken by the user may be to build a specified number of a specified type of structure.

In one embodiment, the natural language model may be a machine learning model or algorithm that is configured to infer the intent of the user from the audio input (i.e. the natural language command). The natural language model may initially be trained using seed data mapping, or otherwise associating, natural language commands and intents. The natural language model may then learn, based on the training, additional associations between natural language commands and intents. The natural language model may be improved over time by continuously learning associations between natural language commands and intents. For example, the natural language model may be retrained using user-provided data or feedback gathered in association with the user's interaction with the application.

As an option, the natural language model may be further configured to infer the intent of the user from both the audio input and a context of the audio input. Similar to that described above, the natural language model may be trained for this particular configuration. The context of the audio input may include any circumstances associated with (e.g. surrounding the receipt of) the audio input. For example, the context may include a particular application running when the audio input is received, or in other words the audio input being received in association with an instantiation of the above mentioned application. By using the context, the natural language model may more accurately infer an intent of the user, for example by inferring the intent with respect to a particular application.

By using the natural language model, the intent of the user may be intelligently inferred from the natural language command, which could not otherwise be accomplished using a simple lookup table or even more specifically a text-to-macro approach mapping certain words or word combinations to certain programmed commands within an application. For example, the natural language model may process the natural language command, the context in which the natural language command is received, a structure of the spoken words in the natural language command (e.g. identification of verbs and predicate nouns, etc.), and possibly other factors to infer the intent of the user.

In operation 106, one or more programmed commands within the application that will accomplish the intent of the user are determined. The programmed commands commands may be included in (e.g. preprogrammed within) logic of the application. In one embodiment, the intent may be mapped to the one or more programmed commands (e.g. in a library of the voice command interface). For example, the intent may be predefined as capable of being accomplished by a particular programmed command within the application or a particular sequence of programmed commands within the application.

It should be noted that operations 102-106 may be continuous, and thus not require a start or stop command for the audio input. In this way, the method 100 may start inferring intents as the natural language commands are continuously received.

In operation 108, the application is caused to perform the programmed command(s). For example, key presses or button presses may be injected into the application that represent the programmed command(s), in order to effect the intent of the user. As another example, the application may be instructed to perform the programmed command(s).

By using the voice command interface in the manner described above, the user can control the application via a spoken natural language command, without the spoken command otherwise being preprogrammed into the application. This may provide the user with a more intuitive way to interact with the application, particularly where the application developer did not otherwise provide voice command support in the application. Furthermore, even where the application developer has provided voice command support in the application, interaction could be simplified for the user by enabling additional (non-programmed) natural language commands that cause a particular sequence of programmed commands, and that therefore possibly cover more complicated combinations of programmed commands (e.g. that may otherwise require navigation through multiple application menus, etc.).

In another example, for video games or other applications having preprogrammed commands that are linked to most or all of the keys on a keyboard, the voice command interface may be used in the manner described above, and with or without a remote controller, to provide the user with complete access to the programmed commands even when not using the keyboard. Additionally, as similarly noted above, interaction with the application could also be simplified for the user by enabling additional (non-programmed) natural language commands that cover more complicated combinations of programmed commands.

More illustrative information will now be set forth regarding various optional architectures and features with which the foregoing framework may be implemented, per the desires of the user. It should be strongly noted that the following information is set forth for illustrative purposes and should not be construed as limiting in any manner. Any of the following features may be optionally incorporated with or without the exclusion of other features described.

Furthermore, it should be noted that any embodiments referencing a video game could equally be applied to any other type of interactive computer application.

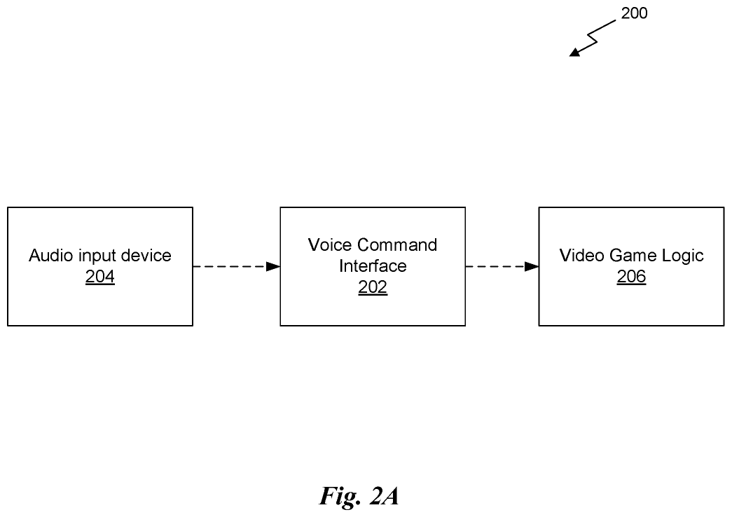

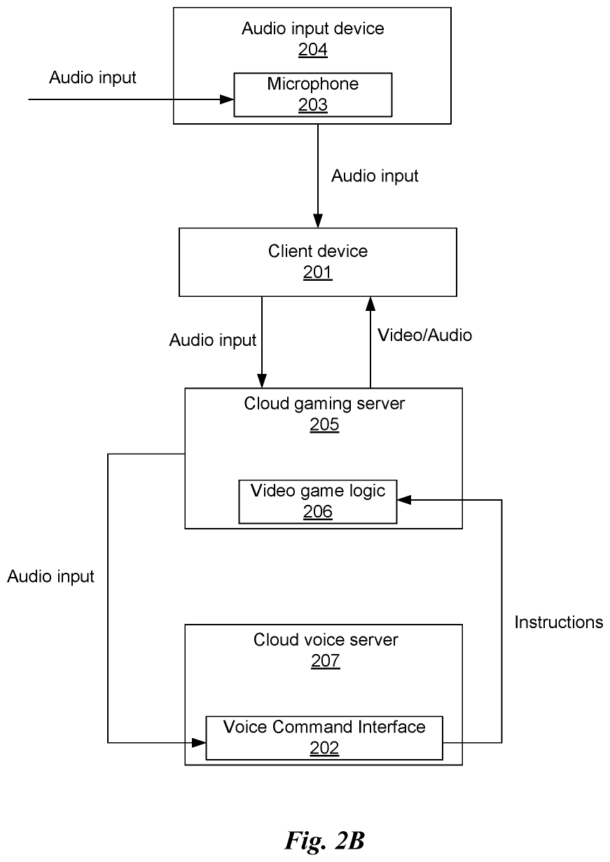

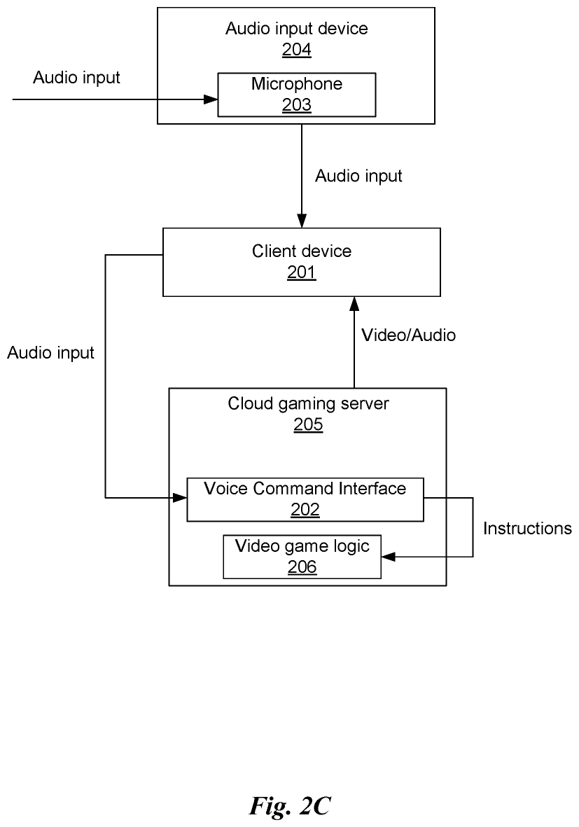

FIG. 2A illustrates a block diagram of a system 200 including a voice command interface 202, in accordance with an embodiment. The voice command interface 202 of the system 200 may be implemented to execute the method 100 of FIG. 1. Further, the voice command interface 202 may be included in a subsystem of the overall system 200 shown. For example, the voice command interface 202 may execute on a client device (e.g. video game console, cable TV console, client computer, etc.) or server device (e.g. located in the cloud).

As shown, the voice command interface 202 is in communication with an audio input device 204. The audio input device 204 includes a microphone for capturing a spoken command of a user. The audio input device 204 may be headphones, a headset, a phone, a remote controller, etc. The voice command interface 202 may be in direct (wired) or wireless communication with the audio input device 204.

The voice command interface 202 receives audio input representing the spoken command from the audio input device 204. In the context of the present embodiment, the spoken command is a natural language command spoken by a user. The voice command interface 202 then processes the audio input to determine an intent of the user. The voice command interface 202 further determines one or more programmed commands that accomplish the intent of the user. The voice command interface 202 uses a locally executing natural language model to determine the intent of the user. The voice command interface 202 may further use a locally stored library to determine the programmed command(s) that accomplish the intent.

As also shown, the voice command interface 202 is in communication with video game logic 206. Of course, it should be noted that the video game logic 206 may likewise be logic of any other type of interactive application. The video game logic 206 may execute on the computing device that also executes the voice command interface 202, or on a computing device that is remote from the computing device executing voice command interface 202. To this end, the voice command interface 202 may be in direct (wired) or wireless communication with the video game logic 206.

The voice command interface 202 causes the video game logic 206 to perform the programmed command(s) determined to accomplish the intent of the user. For example, the voice command interface 202 may instruct the video game logic 206 to perform the programmed command(s). In this way, the voice command interface 202 may interface both the audio input device 204 and the video game logic 206 to allow the user to use spoken natural language commands to control aspects of the video game.

FIG. 2B illustrates a communication path involving the voice command interface of FIG. 2A, in accordance with an embodiment. The communication path represents an embodiment where the voice command interface 202 is executing on a cloud-based computing device remote to the computing device executing the video game logic 206.

As shown, an audio input device 204 includes a microphone 203. The audio input device 204 is a user device capable of being used by a user. The audio input device 204 receives, through the microphone 203, audio input representing a spoken command of the user. The audio input device 204 communicates the audio input to a client device 201. The client device 201 may be a video game console, in one embodiment.

The client device 201 communicates the audio input to a cloud gaming server 205 executing video game logic 206 with which the user is interacting. The cloud gaming server 205 then communicates the audio input to the voice command interface 202 that is executing on a cloud voice server 207 separate from the cloud gaming server 205. Once the voice command interface 202 receives the audio input, the voice command interface 202 can process the audio input as described above with respect to the method 100 of FIG. 1 to determine one or more programmed commands within the video game logic 206 to execute.

The voice command interface 202 communicates instructions to the video game logic 206 to cause execution of the programmed commands by the video game logic 206. The execution of the programmed commands by the video game logic 206 results in video and/or audio of the video game being communicated by the cloud gaming server 205 to the client device 201 for presentation (e.g. display, output, etc.) thereof to the user.

FIG. 2C illustrates another communication path involving the voice command interface of FIG. 2A, in accordance with an embodiment. The communication path of FIG. 2C provides reduced latency with respect to the communication path of FIG. 2B by executing the voice command interface 202 on the same computing device as the video game logic 206, thus avoiding the round-trip communications between the cloud gaming server 205 and the cloud voice server 207 of FIG. 2B.

Similar to FIG. 2B, the audio input device 204 receives, through the microphone 203, audio input representing a spoken command of the user. The audio input device 204 communicates the audio input to the client device 201.

The client device 201 communicates the audio input to the voice command interface 202 executing on the cloud gaming server 205 which also executes the video game logic 206. Once the voice command interface 202 receives the audio input, the voice command interface 202 can process the audio input as described above with respect to the method 100 of FIG. 1 to determine one or more programmed commands within the video game logic 206 to execute.

The voice command interface 202 communicates instructions to the locally executing video game logic 206 to cause execution of the programmed commands by the video game logic 206. The execution of the programmed commands by the video game logic 206 results in video and/or audio of the video game being communicated by the cloud gaming server 205 to the client device 201 for presentation (e.g. display, output, etc.) thereof to the user.

### OPTIONAL ADDITIONAL EMBODIMENTS

In an embodiment, the voice command interface 202 may be configured for a single video game (or other interactive application) or multiple different video games. In the case of the voice command interface 202 being configured for multiple different video games, the audio input may be processed (by the natural language model) in the context of the particular video game being played by the user to infer the intent of the user with respect to the video game.

In an embodiment, the voice command interface 202 can use voice-specific processing as a way to identify the player of the video game (or user of the application) based on voice, and to identify the player as a source of the spoken command while further ignoring background noise or other audio input coming from other people that may also be captured by the audio input device. In an embodiment, the voice command interface 202 can be trained to distinguish between voices of multiple different players simultaneously playing the game (simultaneously interacting with a same execution instance of the application), and thus may differentiate between spoken commands of the different players, even when captured by a shared audio input device. This may enable multiple players to use voice commands in a same environment. Moreover, the customized player library described above could be accessed for each identified player of the game.

In an embodiment, the voice command interface 202 may be selectively enabled by the player. For example, the voice command interface 202 may be enabled during play of the video game in an “always listening” mode to receive all audio input captured using the audio input device 204. As another example, the voice command interface 202 may be enabled during play of the video game in a “push to talk” mode to receive audio input captured using the audio input device 204 on-demand, such as when the player presses a particular button on the remote controller or other input device.

In an embodiment, the voice command interface 202 can execute locally on a computing device executing the video game. In another embodiment, the voice command interface 202 can execute locally on a computing device that is different from the one executing the video game logic 206 (which could be local or in the cloud), in which case output of the voice command interface 202 can be sent to another host or cloud where the video game logic 206 is actually running to causes the video game logic 206 to perform the determined programmed command(s). In another embodiment, the voice command interface 202 can execute on another computing device in communication with the computing device executing the video game logic 206. As shown in FIG. 2C, the reduced latency is provided when the voice command interface 202 executes locally on a computing device executing the video game logic 206 as opposed to on another computing device in communication with the computing device executing the video game logic 206.

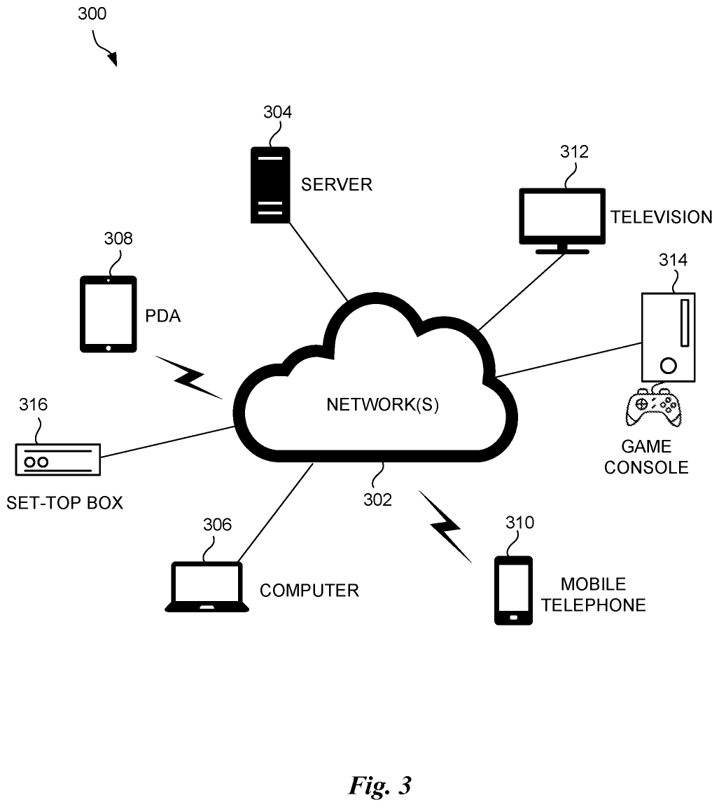

FIG. 3 illustrates a network architecture 300, in accordance with one possible embodiment. As shown, at least one network 302 is provided. In the context of the present network architecture 300, the network 302 may take any form including, but not limited to a telecommunications network, a local area network (LAN), a wireless network, a wide area network (WAN) such as the Internet, peer-to-peer network, cable network, etc. While only one network is shown, it should be understood that two or more similar or different networks 302 may be provided.

Coupled to the network 302 is a plurality of devices. For example, a server computer 304 and an end user computer 306 may be coupled to the network 302 for communication purposes. Such end user computer 306 may include a desktop computer, lap-top computer, and/or any other type of logic. Still yet, various other devices may be coupled to the network 302 including a personal digital assistant (PDA) device 308, a mobile phone device 310, a television 312, a game console 314, a television set-top box 316, etc.

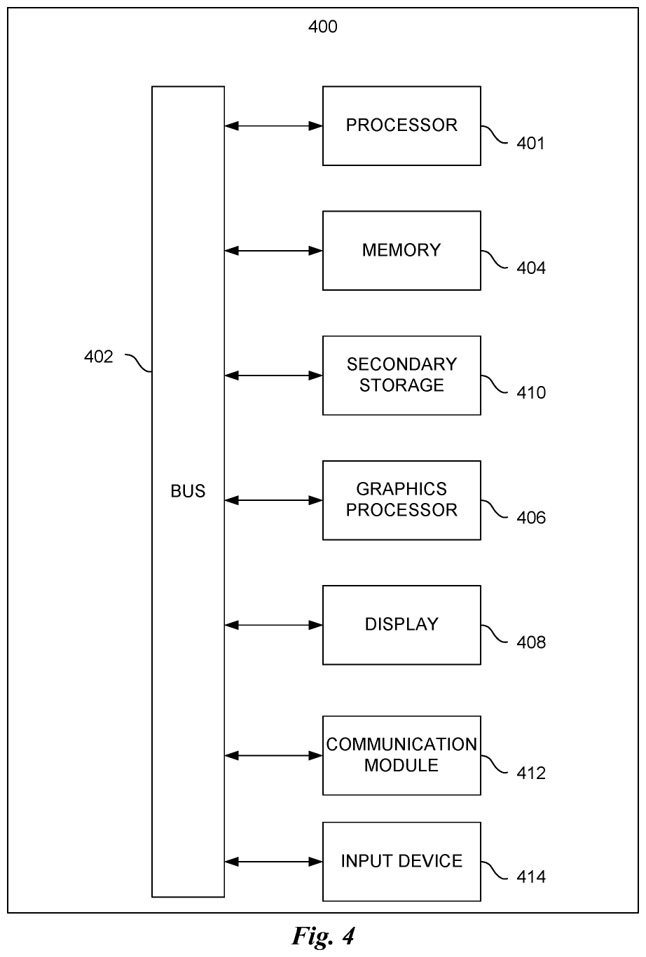

FIG. 4 illustrates an exemplary system 400, in accordance with one embodiment. As an option, the system 400 may be implemented in the context of any of the devices of the network architecture 300 of FIG. 3. Of course, the system 400 may be implemented in any desired environment.

As shown, a system 400 is provided including at least one central processor 401 which is connected to a communication bus 402. The system 400 also includes main memory 404 [e.g. random access memory (RAM), etc.]. The system 400 also includes a graphics processor 406 and a display 408.

The system 400 may also include a secondary storage 410. The secondary storage 410 includes, for example, a hard disk drive and/or a removable storage drive, representing a floppy disk drive, a magnetic tape drive, a compact disk drive, etc. The removable storage drive reads from and/or writes to a removable storage unit in a well-known manner.

Computer programs, or computer control logic algorithms, may be stored in the main memory 404, the secondary storage 410, and/or any other memory, for that matter. Such computer programs, when executed, enable the system 400 to perform various functions (as set forth above, for example). Memory 404, storage 410 and/or any other storage are possible examples of non-transitory computer-readable media.

The system 400 may also include one or more communication modules 412. The communication module 412 may be operable to facilitate communication between the system 400 and one or more networks, and/or with one or more devices through a variety of possible standard or proprietary communication protocols (e.g. via Bluetooth, Near Field Communication (NFC), Cellular communication, etc.).

As also shown, the system 400 may include one or more input devices 414. The input devices 414 may be wired or wireless input device. In various embodiments, each input device 414 may include a keyboard, touch pad, touch screen, game controller (e.g. to a game console), remote controller (e.g. to a set-top box or television), or any other device capable of being used by a user to provide input to the system 400.

### Machine Learning

Deep neural networks (DNNs), including deep learning models, developed on processors have been used for diverse use cases, from self-driving cars to faster drug development, from automatic image captioning in online image databases to smart real-time language translation in video chat applications. Deep learning is a technique that models the neural learning process of the human brain, continually learning, continually getting smarter, and delivering more accurate results more quickly over time. A child is initially taught by an adult to correctly identify and classify various shapes, eventually being able to identify shapes without any coaching. Similarly, a deep learning or neural learning system needs to be trained in object recognition and classification for it get smarter and more efficient at identifying basic objects, occluded objects, etc., while also assigning context to objects.

At the simplest level, neurons in the human brain look at various inputs that are received, importance levels are assigned to each of these inputs, and output is passed on to other neurons to act upon. An artificial neuron or perceptron is the most basic model of a neural network. In one example, a perceptron may receive one or more inputs that represent various features of an object that the perceptron is being trained to recognize and classify, and each of these features is assigned a certain weight based on the importance of that feature in defining the shape of an object.

A deep neural network (DNN) model includes multiple layers of many connected nodes (e.g., perceptrons, Boltzmann machines, radial basis functions, convolutional layers, etc.) that can be trained with enormous amounts of input data to quickly solve complex problems with high accuracy. In one example, a first layer of the DNN model breaks down an input image of an automobile into various sections and looks for basic patterns such as lines and angles. The second layer assembles the lines to look for higher level patterns such as wheels, windshields, and mirrors. The next layer identifies the type of vehicle, and the final few layers generate a label for the input image, identifying the model of a specific automobile brand.

Once the DNN is trained, the DNN can be deployed and used to identify and classify objects or patterns in a process known as inference. Examples of inference (the process through which a DNN extracts useful information from a given input) include identifying handwritten numbers on checks deposited into ATM machines, identifying images of friends in photos, delivering movie recommendations to over fifty million users, identifying and classifying different types of automobiles, pedestrians, and road hazards in driverless cars, or translating human speech in real-time.

During training, data flows through the DNN in a forward propagation phase until a prediction is produced that indicates a label corresponding to the input. If the neural network does not correctly label the input, then errors between the correct label and the predicted label are analyzed, and the weights are adjusted for each feature during a backward propagation phase until the DNN correctly labels the input and other inputs in a training dataset. Training complex neural networks requires massive amounts of parallel computing performance, including floating-point multiplications and additions. Inferencing is less compute-intensive than training, being a latency-sensitive process where a trained neural network is applied to new inputs it has not seen before to classify images, translate speech, and generally infer new information.

### Inference and Training Logic

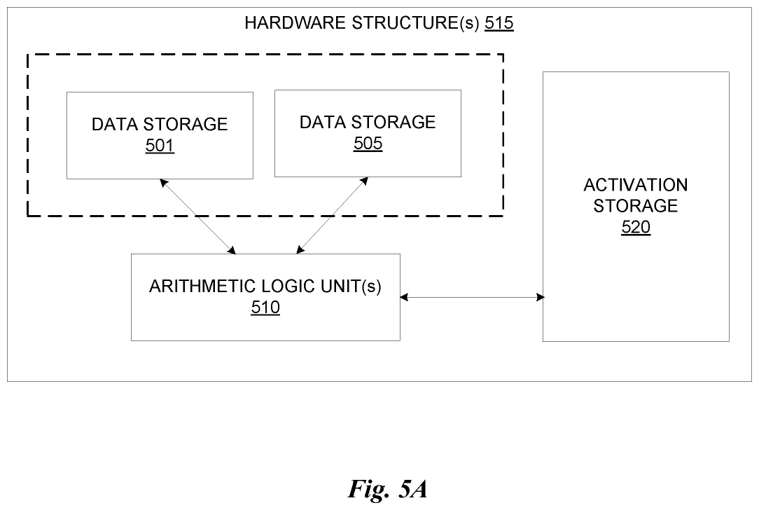

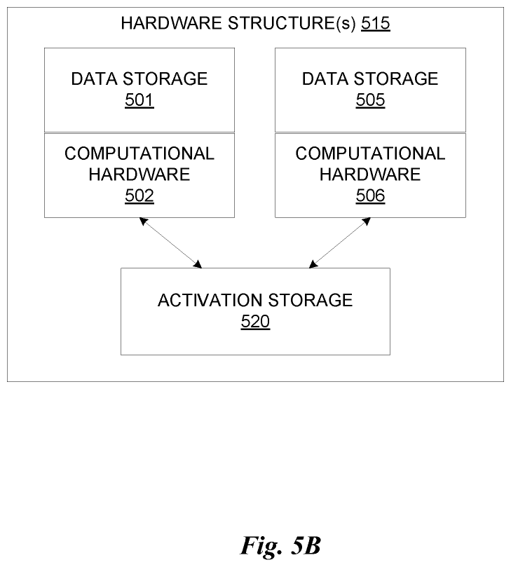

As noted above, a deep learning or neural learning system needs to be trained to generate inferences from input data. Details regarding inference and/or training logic 515 for a deep learning or neural learning system are provided below in conjunction with FIGS. 5A and/or 5B.

In at least one embodiment, inference and/or training logic 515 may include, without limitation, a data storage 501 to store forward and/or output weight and/or input/output data corresponding to neurons or layers of a neural network trained and/or used for inferencing in aspects of one or more embodiments. In at least one embodiment data storage 501 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of data storage 501 may be included with other on-chip or off-chip data storage, including a processor's L1, L2, or L3 cache or system memory.

In at least one embodiment, any portion of data storage 501 may be internal or external to one or more processors or other hardware logic devices or circuits. In at least one embodiment, data storage 501 may be cache memory, dynamic randomly addressable memory (“DRAM”), static randomly addressable memory (“SRAM”), non-volatile memory (e.g., Flash memory), or other storage. In at least one embodiment, choice of whether data storage 501 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 515 may include, without limitation, a data storage 505 to store backward and/or output weight and/or input/output data corresponding to neurons or layers of a neural network trained and/or used for inferencing in aspects of one or more embodiments. In at least one embodiment, data storage 505 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, any portion of data storage 505 may be included with other on-chip or off-chip data storage, including a processor's L1, L2, or L3 cache or system memory. In at least one embodiment, any portion of data storage 505 may be internal or external to on one or more processors or other hardware logic devices or circuits. In at least one embodiment, data storage 505 may be cache memory, DRAM, SRAM, non-volatile memory (e.g., Flash memory), or other storage. In at least one embodiment, choice of whether data storage 505 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, data storage 501 and data storage 505 may be separate storage structures. In at least one embodiment, data storage 501 and data storage 505 may be same storage structure. In at least one embodiment, data storage 501 and data storage 505 may be partially same storage structure and partially separate storage structures. In at least one embodiment, any portion of data storage 501 and data storage 505 may be included with other on-chip or off-chip data storage, including a processor's L1, L2, or L3 cache or system memory.

In at least one embodiment, inference and/or training logic 515 may include, without limitation, one or more arithmetic logic unit(s) (“ALU(s)”) 510 to perform logical and/or mathematical operations based, at least in part on, or indicated by, training and/or inference code, result of which may result in activations (e.g., output values from layers or neurons within a neural network) stored in an activation storage 520 that are functions of input/output and/or weight parameter data stored in data storage 501 and/or data storage 505. In at least one embodiment, activations stored in activation storage 520 are generated according to linear algebraic and or matrix-based mathematics performed by ALU(s) 510 in response to performing instructions or other code, wherein weight values stored in data storage 505 and/or data 501 are used as operands along with other values, such as bias values, gradient information, momentum values, or other parameters or hyperparameters, any or all of which may be stored in data storage 505 or data storage 501 or another storage on or off-chip. In at least one embodiment, ALU(s) 510 are included within one or more processors or other hardware logic devices or circuits, whereas in another embodiment, ALU(s) 510 may be external to a processor or other hardware logic device or circuit that uses them (e.g., a co-processor). In at least one embodiment, ALUs 510 may be included within a processor's execution units or otherwise within a bank of ALUs accessible by a processor's execution units either within same processor or distributed between different processors of different types (e.g., central processing units, graphics processing units, fixed function units, etc.). In at least one embodiment, data storage 501, data storage 505, and activation storage 520 may be on same processor or other hardware logic device or circuit, whereas in another embodiment, they may be in different processors or other hardware logic devices or circuits, or some combination of same and different processors or other hardware logic devices or circuits. In at least one embodiment, any portion of activation storage 520 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 520 may be cache memory, DRAM, SRAM, non-volatile memory (e.g., Flash memory), or other storage. In at least one embodiment, activation storage 520 may be completely or partially within or external to one or more processors or other logical circuits. In at least one embodiment, choice of whether activation storage 520 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors. In at least one embodiment, inference and/or training logic 515 illustrated in FIG. 5A may be used in conjunction with an application-specific integrated circuit (“ASIC”), such as Tensorflow® Processing Unit from Google, an inference processing unit (IPU) from Graphcore™, or a Nervana® (e.g., “Lake Crest”) processor from Intel Corp. In at least one embodiment, inference and/or training logic 515 illustrated in FIG. 5A may be used in conjunction with central processing unit (“CPU”) hardware, graphics processing unit (“GPU”) hardware or other hardware, such as field programmable gate arrays (“FPGAs”).

FIG. 5B illustrates inference and/or training logic 515, according to at least one embodiment. In at least one embodiment, inference and/or training logic 515 may include, without limitation, hardware logic in which computational resources are dedicated or otherwise exclusively used in conjunction with weight values or other information corresponding to one or more layers of neurons within a neural network. In at least one embodiment, inference and/or training logic 515 illustrated in FIG. 5B may be used in conjunction with an application-specific integrated circuit (ASIC), such as Tensorflow® Processing Unit from Google, an inference processing unit (IPU) from Graphcore™, or a Nervana® (e.g., “Lake Crest”) processor from Intel Corp. In at least one embodiment, inference and/or training logic 515 illustrated in FIG. 5B may be used in conjunction with central processing unit (CPU) hardware, graphics processing unit (GPU) hardware or other hardware, such as field programmable gate arrays (FPGAs). In at least one embodiment, inference and/or training logic 515 includes, without limitation, data storage 501 and data storage 505, which may be used to store weight values and/or other information, including bias values, gradient information, momentum values, and/or other parameter or hyperparameter information. In at least one embodiment illustrated in FIG. 5B, each of data storage 501 and data storage 505 is associated with a dedicated computational resource, such as computational hardware 502 and computational hardware 506, respectively. In at least one embodiment, each of computational hardware 506 comprises one or more ALUs that perform mathematical functions, such as linear algebraic functions, only on information stored in data storage 501 and data storage 505, respectively, result of which is stored in activation storage 520.

In at least one embodiment, each of data storage 501 and 505 and corresponding computational hardware 502 and 506, respectively, correspond to different layers of a neural network, such that resulting activation from one “storage/computational pair 501/502” of data storage 501 and computational hardware 502 is provided as an input to next “storage/computational pair 505/506” of data storage 505 and computational hardware 506, in order to mirror conceptual organization of a neural network. In at least one embodiment, each of storage/computational pairs 501/502 and 505/506 may correspond to more than one neural network layer. In at least one embodiment, additional storage/computation pairs (not shown) subsequent to or in parallel with storage computation pairs 501/502 and 505/506 may be included in inference and/or training logic 515.

### Neural Network Training and Deployment

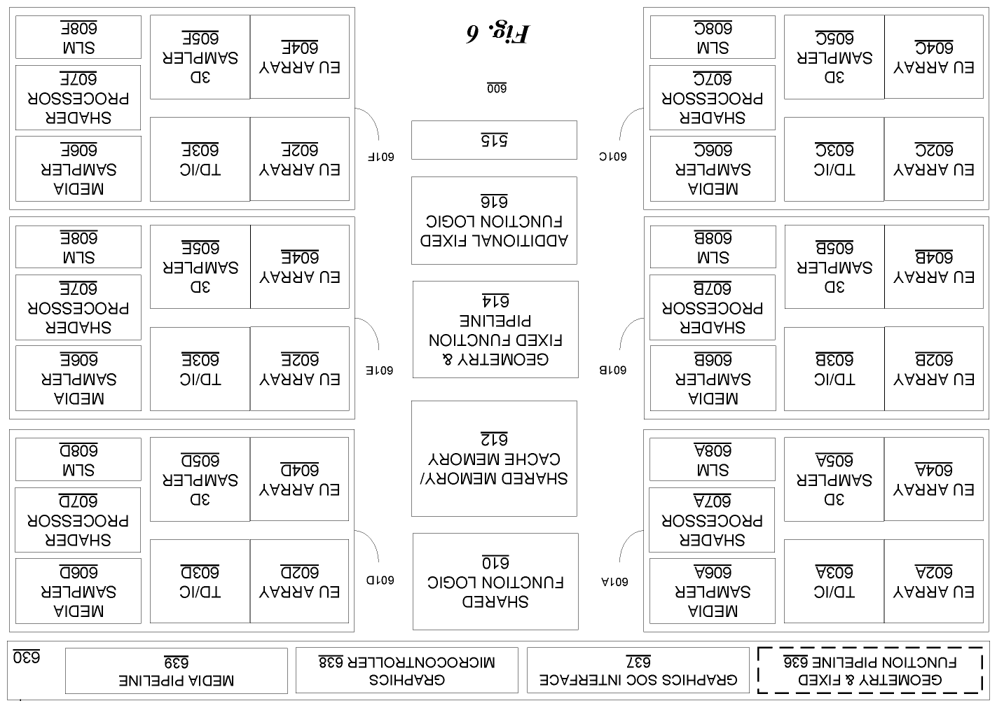

FIG. 6 illustrates another embodiment for training and deployment of a deep neural network. In at least one embodiment, untrained neural network 606 is trained using a training dataset 602. In at least one embodiment, training framework 604 is a PyTorch framework, whereas in other embodiments, training framework 604 is a Tensorflow, Boost, Caffe, Microsoft Cognitive Toolkit/CNTK, MXNet, Chainer, Keras, Deeplearning4j, or other training framework. In at least one embodiment training framework 604 trains an untrained neural network 606 and enables it to be trained using processing resources described herein to generate a trained neural network 608. In at least one embodiment, weights may be chosen randomly or by pre-training using a deep belief network. In at least one embodiment, training may be performed in either a supervised, partially supervised, or unsupervised manner.

In at least one embodiment, untrained neural network 606 is trained using supervised learning, wherein training dataset 602 includes an input paired with a desired output for an input, or where training dataset 602 includes input having known output and the output of the neural network is manually graded. In at least one embodiment, untrained neural network 606 is trained in a supervised manner processes inputs from training dataset 602 and compares resulting outputs against a set of expected or desired outputs. In at least one embodiment, errors are then propagated back through untrained neural network 606. In at least one embodiment, training framework 604 adjusts weights that control untrained neural network 606. In at least one embodiment, training framework 604 includes tools to monitor how well untrained neural network 606 is converging towards a model, such as trained neural network 608, suitable to generating correct answers, such as in result 614, based on known input data, such as new data 612. In at least one embodiment, training framework 604 trains untrained neural network 606 repeatedly while adjust weights to refine an output of untrained neural network 606 using a loss function and adjustment algorithm, such as stochastic gradient descent. In at least one embodiment, training framework 604 trains untrained neural network 606 until untrained neural network 606 achieves a desired accuracy. In at least one embodiment, trained neural network 608 can then be deployed to implement any number of machine learning operations.

In at least one embodiment, untrained neural network 606 is trained using unsupervised learning, wherein untrained neural network 606 attempts to train itself using unlabeled data. In at least one embodiment, unsupervised learning training dataset 602 will include input data without any associated output data or “ground truth” data. In at least one embodiment, untrained neural network 606 can learn groupings within training dataset 602 and can determine how individual inputs are related to untrained dataset 602. In at least one embodiment, unsupervised training can be used to generate a self-organizing map, which is a type of trained neural network 608 capable of performing operations useful in reducing dimensionality of new data 612. In at least one embodiment, unsupervised training can also be used to perform anomaly detection, which allows identification of data points in a new dataset 612 that deviate from normal patterns of new dataset 612.

In at least one embodiment, semi-supervised learning may be used, which is a technique in which in training dataset 602 includes a mix of labeled and unlabeled data. In at least one embodiment, training framework 604 may be used to perform incremental learning, such as through transferred learning techniques. In at least one embodiment, incremental learning enables trained neural network 608 to adapt to new data 612 without forgetting knowledge instilled within network during initial training.

As described herein, a method, computer readable medium, and system are disclosed to provide a voice command interface for video games and other types of interactive computer applications. In accordance with FIGS. 1-2C, an embodiment may provide a machine learning model usable by the voice command interface, where the machine learning model is stored (partially or wholly) in one or both of data storage 501 and 505 in inference and/or training logic 515 as depicted in FIGS. 5A and 5B. Training and deployment of the machine learning model may be performed as depicted in FIG. 6 and described herein.

What is claimed is:

1. A method, comprising:
receiving audio input representing a natural language command spoken by a user;
processing the audio input using a natural language model to determine an intent of the user;
determining one or more programmed commands within an application that accomplish the intent of the user; and
causing the application to perform the one or more programmed commands.

2. The method of claim 1, wherein the method is performed by a voice command interface.

3. The method of claim 2, wherein the voice command interface executes locally on a computing device executing the application.

4. The method of claim 1, wherein the audio input is received from an audio input device.

5. The method of claim 4, wherein the audio input device includes a microphone.

6. The method of claim 1, wherein the application is a video game.

7. The method of claim 1, wherein the one or more programmed commands are included in logic of the application.

8. The method of claim 1, wherein the natural language model is a machine learning model.

9. The method of claim 1, wherein the natural language model infers the intent of the user from the audio input and a context of the audio input.

10. The method of claim 9, wherein the context of the audio input includes the audio input being received in association with an instantiation of the application.

11. The method of claim 1, wherein the one or more programmed commands within the application that accomplish the intent are determined based on a mapping of the one or more programmed commands to the intent.

12. The method of claim 1, wherein causing the application to perform the one or more programmed commands includes injecting key presses or button presses into the application that represent the one or more programmed commands in order to effect the intended result.

13. The method of claim 1, further comprising using voice-specific processing to identify a user from a plurality of users as a source of the natural language command.

14. The method of claim 13, wherein the voice-specific processing distinguishes between voices of the plurality of users when the plurality of users are simultaneously interacting with a same execution instance of the application.

15. A system, comprising:
a processor executing a voice command interface, wherein the voice command interface is in communication with an audio input device and an application, and wherein the voice command interface is executed to perform a method comprising:
receiving, from the audio input device, audio input representing a natural language command spoken by a user;
processing the audio input using a natural language model to determine an intent of the user;
determining one or more programmed commands within the application that will accomplish the intent of the user; and
causing the application to perform the one or more programmed commands.

16. The system of claim 15, wherein the voice command interface executes locally on a computing device executing the application.

17. The system of claim 15, wherein the computing device executing the application is a client device or a cloud-based device.

18. The system of claim 15, wherein the voice command interface executes locally on a first computing device remote to a second computing device executing the application.

19. The system of claim 17, wherein the first computing device is a first cloud-based server and the second computing device is a second cloud-based server.

20. A non-transitory computer-readable media storing computer instructions which when executed by one or more processors cause the one or more processors to perform a method comprising:
receiving audio input representing a natural language command spoken by a user;
processing the audio input using a natural language model to determine an intent of the user;
determining one or more programmed commands within an application that accomplish the intent of the user; and
causing the application to perform the one or more programmed commands.
